(19) United States
(12) Patent Application Publication
(10) Pub. No.: US 2023/0297827 A1
(43) Pub. Date: Sep. 21, 2023

(54) LEARNING METHOD AND LEARNING APPARATUS FOR PERFORMING VIRTUAL-ACTUAL CORRECTION BY MACHINE LEARNING-ASSISTED SIMULATION OF PRESSURE NUMERICAL VALUE

(71) Applicant: National Kaohsiung University of Science and Technology, Kaohsiung City (TW)

(72) Inventors: Ming-Shyan HUANG, Kaohsiung City (TW); Chun-Ying LIU, Kaohsiung City (TW); Kun-Cheng KE, Kaohsiung City (TW)

(21) Appl. No.: 17/699,861

(22) Filed: Mar. 21, 2022

(51) Int. Cl. G06N 3/08; G06F 30/27

(52) U.S. Cl. CPC G06N 3/08; G06F 30/27; G06F 2119/18

(57) ABSTRACT

Disclosed is a learning method for performing virtual-actual correction by machine learning-assisted simulation of a pressure numerical value, the method including: in a pre-step: obtaining actual production data of executing a process parameter by a production device; in a first extraction step: analyzing the actual production data using an autoencoder to obtain a plurality of first features; in a simulation step: executing simulated production data of the process parameter using a production prediction model; in a second extraction step: analyzing the simulated production data using the autoencoder to obtain a plurality of second features; and in a training step: training the plurality of first features and the plurality of second features using a multilayer perceptron (MLP) to obtain a correction model, wherein the correction model can be provided for the MLP to correct the simulated production data into the corresponding actual production data.

### FIELD OF TECHNOLOGY

The present invention relates to a learning method, in particular relates to a learning method and a learning apparatus capable of performing virtual-actual correction by machine learning-assisted simulation of a pressure numerical value.

### BACKGROUND

Complex parts can be produced through an injection molding processing technology, but processing conditions are complex; a polymer plasticized material is heated and pressurized to fill the mold, and then compressed and cooled to obtain an injection molding product; in a general plastic injection process from mold development to stable output of the injection molding product, the process parameters need to be repeatedly adjusted, and in the early days, the process parameter can be obtained quickly only by relying on experienced masters, however, the personnel training is not easy, and there are various uncertainties in the adjustment of the processing conditions of the injection molding products by relying on the experiences.

With the development of science technology, the injection molding industry is gradually moving towards intelligent manufacturing, that is, the computer is used to adjust parameters. Such manufacturing heavily relies on computing technology such as computer-aided engineering simulation techniques which can be used to optimize the product design, mold design and appearance of the actual product. With developments in mathematical modeling technology, the flow behavior of the melt in the cavity, cavity pressure, clamping force required by the mold, system pressure required by the machine, and cooling time required for achieving a certain quality of finished product can be presented using injection molding simulation software (such as Moldflow or Moldex3D).

To stabilize the production quality of the injection molding product, in addition to monitoring the quality of the produced injection molding product, the production parameters must also be monitored, and a common monitoring method at present is pressure-volume-temperature (pvT), the quality of the injection molding product is controlled by adjusting the pressure and the temperature, and the cavity pressure integral is used as an indicator of molding quality for monitoring. Abnormal change in the weight of the injection molding product can be further reduced by adopting above monitoring method.

In the development stage of the injection molding product, the process parameters are tested to find the optimal process parameters for production. The process parameters for general injection molding include melt temperature, cooling time, injection temperature, velocity-to-pressure (V/P) switchover, pressure holding time, clamping force and the like. G. Xu, Z. Yang, Int. J. Adv. Manuf. Technol. 2015, 78, 525. disclosed an intelligent analysis method based on parameter calculation and gray model correlation to obtain the optimal process parameters.

Although a technology capable of monitoring the injection molding product is disclosed in the prior art, the following defects still exist in the actual use:
1. The simulation is unreal:

there are limitations in revealing or simulating physical information of the melt in the mold cavity. Many factors, such as simplified mathematical models, incorrect processing conditions, material property settings, mold rigidity and machine aging may cause the simulation results to be inconsistent with the actual molding results.
2. The product is long in development time:

due to the fact that the simulated operation status and the actual sensed machine status are inaccurate, the process parameters obtained by simulation need to be adjusted in actual use, and therefore the development time of the injection molding product may be prolonged.
3. The simulation cannot be used as a reference for comparison:

when the simulated result is inconsistent with the production status detected by the injection molding machine, the simulation data must also be corrected by professionals and cannot be used directly as a reference for actual parameter comparison to further monitor the production result of the injection molding product.

Therefore, how to improve the process simulation data of injection molding to be more similar to the actual sensing data to make the developer of the injection molding product adjust the process parameters through simulation and use the simulated process parameters as a monitoring reference in the manufacturing process of the injection molding product is an urgent target for related technicians to strive for.

### SUMMARY

Therefore, an objective of the present invention is to provide a learning method for performing virtual-actual correction by machine learning-assisted simulation of a pressure numerical value.

The learning method for performing virtual-actual correction by machine learning-assisted simulation of the pressure numerical value comprises a pre-step, a first extraction step, a simulation step, a second extraction step, a training step, an importing step, and a correction step.

In the pre-step, a process parameter is set in a production device for production, and a production status of the production device is detected to obtain actual production data.

In the first extraction, the actual production data is input into an autoencoder to extract a plurality of first features.

In the simulation step, a production prediction model is provided, which operates based on the process parameter to produce simulated production data.

In the second extraction step, the simulated production data is input into the autoencoder to extract a plurality of second features.

In the training step, the plurality of first features and second features are input into a multilayer perceptron (MLP) for training to obtain a correction model.

In the importing step, another simulated production data is input into the autoencoder to extract a plurality of third features.

In the correction step, the MLP calculates the third features using the correction model to obtain a plurality of corrected features, and the plurality of corrected features are decoded by the autoencoder to obtain corrected simulation data.

In some embodiments, in the training step, the MLP can correct the second features into the first features by the correction model.

In some embodiments, in the pre-step and the simulation step, the maximum values of the actual production data and the simulated production data are set to be 1, the minimum values of the actual production data and the simulated production data are set to be 0, and the rest numerical values of the actual production data and the simulated production data are calculated according to the proportion to obtain a plurality of data ranging from 0 to 1.

In some embodiments, in the importing step, another simulated production data is a result produced by an operation of importing another process parameter by the production prediction model.

In some embodiments, the learning method for performing virtual-actual correction by machine learning-assisted simulation of the pressure numerical value further comprises a comparison step after the correction step, the comparison step comprises setting the another process parameter in the production device for production, and detecting a production status of the production device to obtain another actual production data, and then judging whether the another actual production data is the same as the corrected simulation data or not.

In some embodiments, in the pre-step, the production device is an injection molding machine, and the process parameter is selected from one or a combination of a filling stroke, a material barrel temperature, a screw rotating speed, injection pressure, pressure holding time, cooling time, a mold temperature, a clamping force, an injection speed, a filling pressure holding switchover point, and holding pressure.

In some embodiments, in the pre-step, the production device comprises a mold having at least one mold cavity, the mold being provided with at least one pressure sensor for detecting the pressure of the mold cavity to become the actual production data.

Another objective of the present invention is to provide a learning apparatus.

The learning apparatus comprises a simulation correction unit, a production simulation unit, and a production storage unit.

The simulation correction unit comprises a correction learning module and a correction storage module connected to the correction learning module, and a multilayer perceptron (MLP) is stored in the correction learning module.

The production simulation unit comprises a simulation result storage module connected to the correction learning module, a production simulation module connected to the simulation result storage module, and a parameter storage module connected to the production simulation module, wherein a process parameter is stored in the parameter storage module, a production prediction model is stored in the production simulation module, the production prediction module corresponds to production operation characteristics of a production device, the production simulation module executes the production prediction module using the process parameter to produce simulated production data, and the simulated production data is stored in the simulation result storage module.

The production storage module comprises a production result storage module connected to the correction learning module, and actual production data, which is an operation status of executing the process parameter by the production device, is stored in the production result storage module.

The correction learning module analyzes the simulated production data and the actual production data using the MLP to obtain a correction model, and the correction model is stored in the correction storage module.

In some embodiments, the simulation correction unit further comprises a simulation correction module connected to the correction storage module, the production simulation unit further comprises a correction result storage module connected to the simulation correction module, the MLP is stored in the simulation correction module, the simulation correction module applies the correction model to the MLP to calculate the simulated production data to obtain corrected simulation data, and the corrected simulation data is stored in the correction result storage module.

In some embodiments, the learning apparatus further comprises a production monitoring unit, the production monitoring unit comprises a data comparison module connected to the production result storage module and the correction result storage module, the data comparison module analyzing whether the actual production data is the same as the corrected simulation data or not.

The learning method and learning apparatus provided by the present invention have beneficial effects as follows: because the production prediction model cannot completely simulate the production device actually used, leading to errors between the simulated production data and the actual production data. The MLP is an artificial neural network (ANN), usually simply called a neural network (NN) or a simulated neural network, which may perform analysis and learning for multiple times using the simulated production data and the actual production data and then obtain the correction model through the difference between the simulated production data and the actual production data; and the correction model can be provided for the MLP to correct the simulated production data into correct data.

### BRIEF DESCRIPTION OF THE DRAWINGS

FIG. 1 is a setting diagram of an apparatus, which is a first preferred embodiment of the present invention and illustrates setting states of a production device and a learning apparatus;

FIG. 2 is a stereoscopic diagram illustrating shapes of two mold cavities in the first preferred embodiment;

FIG. 3 is a diagram illustrating a model structure of a multilayer perceptron (MLP) used in the production device in the first preferred embodiment;

FIG. 4 is a flow diagram illustrating a learning method for performing virtual-actual correction by machine learning-assisted simulation of a pressure numerical value in the first preferred embodiment;

FIG. 5 is a diagram illustrating a method for performing learning training using the MLP in the learning method for performing virtual-actual correction by machine learning-assisted simulation of the pressure numerical value in the first preferred embodiment;

FIG. 6 is a curve chart illustrating simulated production data obtained in the first preferred embodiment;

FIG. 7 is a curve chart illustrating feature curves based on the simulated production data in the first preferred embodiment;

FIG. 8 is a curve chart illustrating actual production data obtained in the first preferred embodiment;

FIG. 9 is a curve chart illustrating feature curves based on the actual production data in the first preferred embodiment;

FIG. 10 is a diagram illustrating a state of correcting the simulated production data into corrected simulation data in the learning method for performing virtual-actual correction by machine learning-assisted simulation of the pressure numerical value in the first preferred embodiment;

FIG. 11 is a curve chart illustrating corrected simulation data obtained in the first preferred embodiment;

FIG. 12 is a setting diagram of an apparatus, which is a second preferred embodiment of the present invention and illustrates setting states of a production device and a learning apparatus;

FIG. 13 is a flow chart illustrating a learning method for performing virtual-actual correction by machine learning-assisted simulation of a pressure numerical value in the second preferred embodiment; and

FIG. 14 is a diagram illustrating a state of monitoring the production device using the corrected simulation data in the second preferred embodiment.

### DESCRIPTION OF THE EMBODIMENTS

The relevant patent characteristics and technical content of the present invention will be clearly presented in the following detailed description of two preferred embodiments with reference to the accompanying drawings. Prior to performing detailed description, it should be noted that similar assemblies are represented by same numbers.

An objective of a learning method and a learning apparatus for performing virtual-actual correction by machine learning-assisted simulation of a pressure numerical value of the present invention is to simulate a sensing status of a production device 201 during operation. Preferably, the production device 201 is an injection molding machine used for an injection molding product of a plastic material. In practice, the production device 201 may employ the production machines for other types of products, such as a metal punching machine and other devices capable of detecting pressure at different stages, which should not be limited thereto.

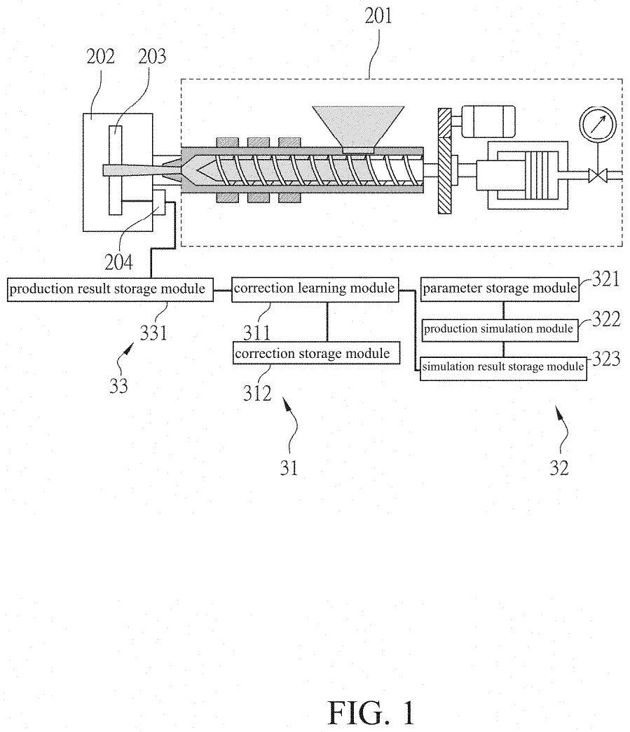

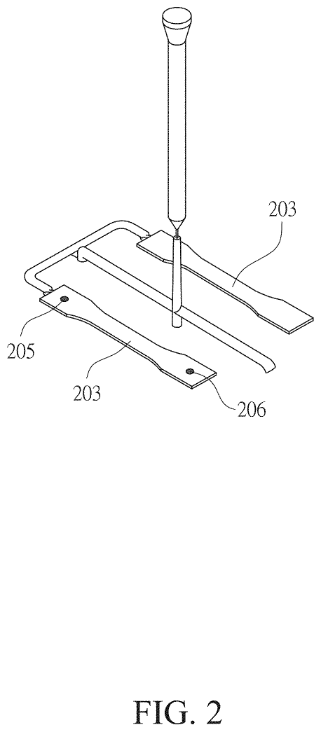

Please referring to FIG. 1 and FIG. 2, a first preferred embodiment of the learning apparatus is illustrated, the production device 201 employs a mold 202 which surrounds and defines two mold cavities 203 for producing the injection molding product; a plurality of pressure sensors 204 are arranged on the mold 202, and are respectively used to detect the pressure of the mold cavities 203 by using a first sensing position 205 and a second sensing position 206; the pressure of the mold cavity 203 at the first sensing position 205 is used for illustration in the first preferred embodiment; in practice, the number and shape of the molds 202 and the inner cavities 203, and the number and position of the pressure sensors 204 should be set according to actual status, and should not be limited thereto.

In the first preferred embodiment, the learning apparatus is a computer, the learning apparatus is electrically connected to the production device 201, the production device 201 may have its own computer for the setting of process parameters to perform the production operation of the injection molding product; in practice, the production device 201 may be controlled directly using the learning apparatus, which should not be limited thereto. The learning apparatus comprises a simulation correction unit 31, a production simulation unit 32, and a production storage unit 33.

The simulation correction unit 31 comprises a correction learning module 311, and a correction storage module 312 connected to the correction learning module 311; the correction learning module 311 is a control circuit capable of executing programs, a multilayer perceptron (MLP) is stored in the correction learning module 311, and the correction storage module 312 is a data storage circuit.

The production simulation unit 32 comprises a parameter storage module 321, a production simulation module 322, and a simulation result storage module 323; the simulation result storage module 323 is connected to the correction learning module 311, the production simulation module 322 is connected to the simulation result storage module 323, and the parameter storage module 321 is connected to the production simulation module 322; the parameter storage module 321 is a data storage electronic circuit for storing a process parameter, the production simulation module 322 is a control circuit capable of executing programs, and a production prediction model is stored in the production simulation module 322; the production prediction model corresponds to the production operation features of the production device 201 and can be used for simulating the production status and the operation status of the production device 201 by using the process parameters; the simulation result is used as simulated production data to be stored in the simulation result storage module 323, and the simulation result storage module 323 is a data storage circuit, wherein the simulated production data is mainly to simulate the sensing data of the pressure sensor 204 at the first sensing position 205; and in practice, the simulated production data can be applied to simulating other types of sensing data, which is not limited thereto.

The production storage unit 33 comprises a production result storage module 331 connected to the correction learning module 311, and the production result storage module 331 is a data storage circuit used for storing actual production data of the production device 201 during operation, wherein the actual production data is an operation status of executing the process parameter by the production device 201; preferably, the actual production data can be stored in the production result storage module 331 through a mobile data storage device (USB flash drive); in practice, the actual production data can be directly obtained by connecting the production device 201 through a transmission line, which should not be limited thereto, wherein the actual production data is the sensing data of the pressure sensor 204 at the first sensing position 205.

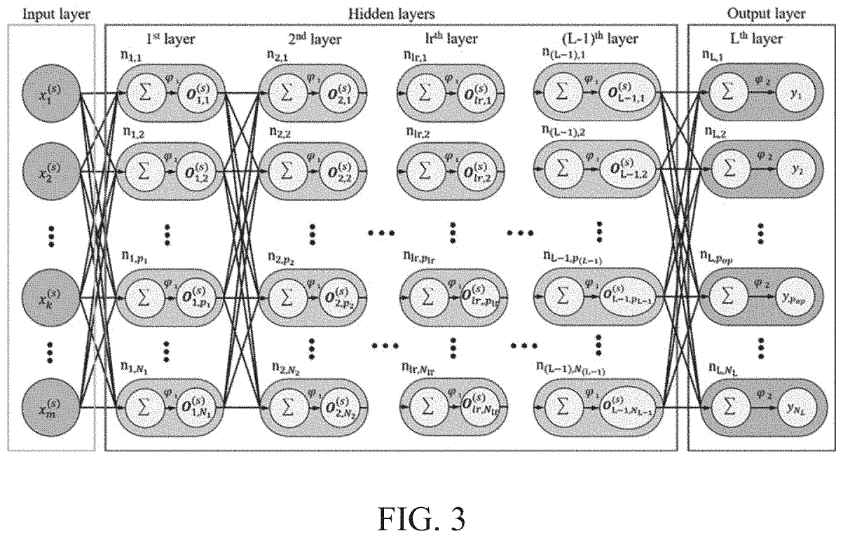

Please referring to FIG. 3, a model structure of the MLP is illustrated. The MLP is an artificial neural network (ANN), simply called a neural network (NN) or a simulated neural network, including an input layer, an output layer, and a hidden layer. The input layer receives a large amount of non-linear input messages for numerous neurons, and the input message is called an input vector; the message of the output layer is transmitted, analyzed and balanced in the neuron link to form an output result, and the output message is called an output vector; the hidden layer is each layer consisting of numerous neurons and links between the input layer and the output layer, the number of the hidden layers can be one or more, the number of nodes (neurons) of the hidden layer is variable, but the more the number is, the more remarkable the nonlinearity of the neural network is. The correction learning module 311 analyzes the simulated production data and the actual production data using the MLP to learn and obtain a correction model, and then the correction model is stored in the correction storage module 312. In the model structure of FIG. 3, in addition to the nodes of the input layer, each node is one neuron using a nonlinear threshold activation function; the MLP is trained using a back-propagation supervised learning technology, wherein xₖ^{(S)} denotes the K-th input data of the S-th set of data, m is the total number of the input data, n_{lr,p}_{ₗᵣ} is the pₗᵣ neural node of the lr-th layer, Nₗᵣ is the total number of neurons in the lr-th layer, x^{(S)} denotes the vector of the input data, Nₛₑₜ is the total number of data points in an input data set, L is the sum of all layers except for the input layer, lr is the number of layers of the neurons, and Oₗᵣ^{(S)} denotes an output vector of the lr-th layer after training from the first dataset to the S-th dataset; the following equations (1)-(6) respectively reveal output vectors of the hidden layer, the first layer and the output layer, Wₗᵣ denotes a weight vector of the lr-th layer, with a weight value ranging from 0 to 1; these values change as the training data changes, and represent the memory of the neural network related to input-output after model training.

when

$$L > lr \geq 2 , \qquad ( 1 )$$

$${O}_{lr}^{( S )} = {φ}_{1} ( {O}_{lr - 1}^{( S )} \times {w}_{lr} + {b}_{lr}^{T} ) ;$$

$$wherein \qquad ( 2 )$$

$${O}_{lr}^{( S )} = [ {O}_{lr , 1}^{( S )} {O}_{lr , 2}^{( S )} … {O}_{lr , {N}_{lr}}^{( S )} ] ;$$

$${w}_{lr} = [ \begin{matrix}{w}_{lr , 1 , 1} & {w}_{lr , 2 , 1} & … & {w}_{lr , {N}_{lr} , 1} \\ {w}_{lr , 1 , 2} & {w}_{lr , 2 , 2} & … & {w}_{lr , {N}_{lr} , 2} \\ ⋮ & ⋮ & ⋱ & ⋮ \\ {w}_{lr , 1 , {N}_{lr - 1}} & {w}_{lr , 2 , {N}_{lr} - 1} & … & {w}_{lr , {N}_{lr} , {N}_{lr - 1}}\end{matrix} ] ; \qquad ( 3 )$$

$${b}_{lr} = \begin{matrix}\begin{matrix}\begin{matrix}{b}_{lr , 1} \\ {b}_{lr , 2}\end{matrix} \\ ⋮\end{matrix} \\ ⌊ {b}_{lr , {N}_{lr}} ⌋\end{matrix} ; \qquad ( 4 )$$

$$when lr = 1 , \qquad ( 5 )$$

$${O}_{1}^{( S )} = {φ}_{1} ( {X}^{( S )} \times {w}_{1} + {b}_{1}^{T} ) ;$$

$$when lr = L , \qquad ( 6 )$$

$${O}_{L}^{( S )} = {φ}_{2} ( {O}_{L - 1}^{( S )} \times {w}_{L} + {b}_{L}^{T} ) .$$

In the first preferred embodiment, the simulated production data is set in the input layer of the MLP, the actual production data is set in the output layer of the MLP, and the correction model is provided in the hidden layer of the MLP; the MLP can obtain the correction model in the hidden layer through multiple times of learning of the input layer and the output layer, wherein the simulated production data and the actual production data are numerous simulated data and actual sensing data, and can be expressed by the following formula to enter the MLP to learn and obtain the correction model:

y=φ(xw+b);

wherein φ is a radial function, x is the input vector of the input layer, w is a weighted vector, b is a deviation value, and y is an output value of the output layer.

Preferably, the weight value must be adjusted to range from 0 to 1 after obtaining the simulated production data and the actual production data. In other words, the maximum values of the actual production data and the simulated production data are set to be 1, the minimum values of the actual production data and the simulated production data are set to be 0, and actual values of the rest data are then calculated according to the proportion of the maximum values to obtain a plurality of calculated values, with the formula as follows:

$${X}_{norm} = \frac{X - {X}_{min}}{{X}_{max} - {X}_{min}} ;$$

wherein

Xₙₒᵣₘ is a calculated value:

X is an actual value;

Xₘₐₓ is the maximum value of the actual production data and the simulated production data;

Xₘᵢₙ is the minimum value of the actual production data and the simulated production data.

Because the production prediction model is used to simulate the production status and the operation status of the production device 201, after the production prediction model performs simulated calculation using the process parameters, the obtained simulated production data has an error with the actual production data, and even the error of the simulated production data is up to 20% or above. The MLP learns the difference between the simulated production data and the actual production data using the neural network and obtains the correction model; the correction model may be provided for other module with the MLP to correct the simulated production data, thus making the corrected data be the same as the actual production data. In practice, the corrected data and the actual production data have a similarity up to 99.9% or above, and are regarded as the same data.

It is worth mentioning that, after the correction learning module 311 finishes learning and obtains correction model, the correction model can provide process parameters of different numerical values for simulation operation, and correct simulation data can be obtained after correction operation, thus the developer of the injection molding product can utilize the learning apparatus to perform simulation development of the product, the process parameter is adjusted to be optimal at first, and then is tested in the production device 201, so that the development time of the product can be greatly reduced, and the development cost of the product can be saved.

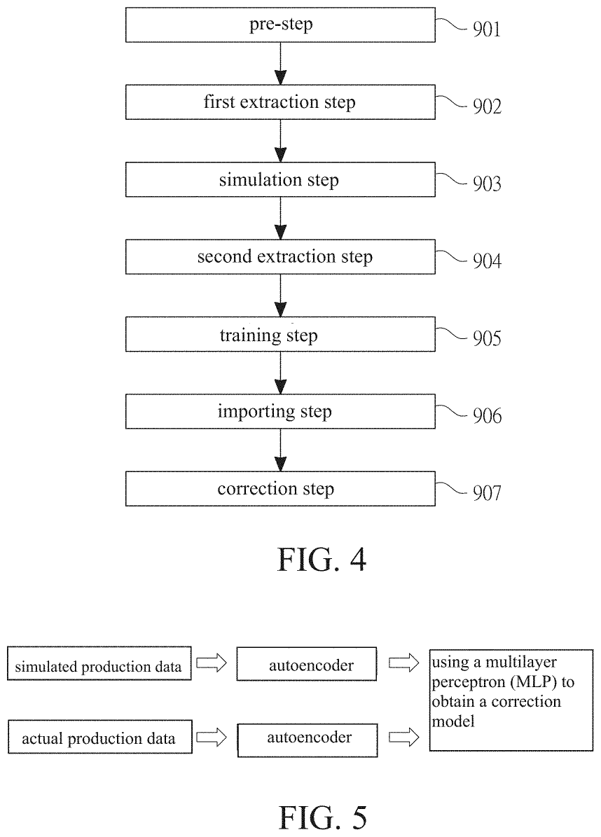

Please referring to FIG. 4 and FIG. 5, a learning method for performing virtual-actual correction by machine learning-assisted simulation of a pressure numerical value is illustrated. The learning method for performing virtual-actual correction by machine learning-assisted simulation of the pressure numerical value comprises a pre-step 901, a first extraction step 902, a simulation step 903, a second extraction step 904, a training step 905, an importing step 906, and a correction step 907.

In the pre-step 901, a process parameter is set in the production device 201 for production, and a production status of the production device 201 is detected to obtain actual production data. Preferably, the actual production data is obtained by sensing the pressure of the mold cavity 203 at the first sensing position 205 by using the pressure sensor 204, wherein the process parameter is selected from one or a combination of a filling stroke, a material barrel temperature, a screw rotating speed, injection pressure, pressure holding time, cooling time, a mold temperature, a clamping force, an injection speed, a filling-pressure holding switchover point, and holding pressure. In the first preferred embodiment, the process parameters include fixed parameters and variable parameters, the fixed parameters are the filling stroke (40 mm), the material barrel temperature (483° K), the screw rotating speed (100 rpm), the injection pressure (180 MPa), the pressure holding time (8 seconds), the cooling time (15 seconds), the mold temperature (333° K), the clamping force (600) kN), and the third holding pressure (10 MPa); in addition, the variable parameters are shown in Table (1).

TABLE 1

| | Injection | V/P | The first | The second |
|---|---|---|---|---|
| | speed | switchover | holding pressure | holding pressure |
| NO | (mm/s) | (mm) | (MPa) | (MPa) |
| Exp1 | 48 | 6.48 | 102 | 68 |
| Exp2 | 48 | 6.19 | 136 | 102 |
| Exp3 | 48 | 5.89 | 170 | 136 |
| Exp4 | 60 | 6048 | 136 | 136 |
| Exp5 | 60 | 6.19 | 170 | 68 |
| Exp6 | 60 | 5.89 | 102 | 102 |
| Exp7 | 72 | 6.48 | 170 | 102 |
| Exp8 | 72 | 6.19 | 102 | 136 |
| Exp9 | 72 | 5.89 | 136 | 68 |

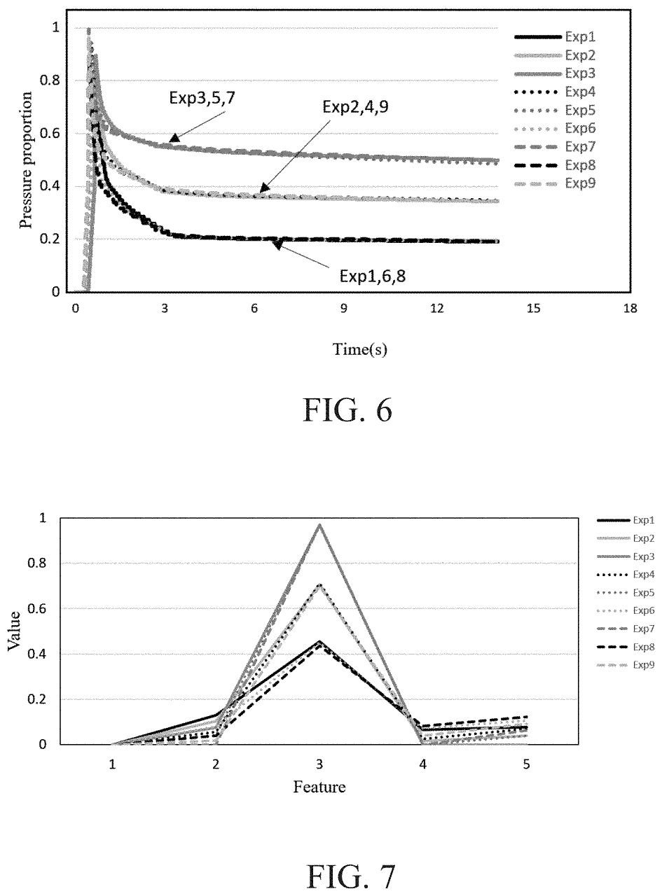

Please referring to FIG. 6, curves of the actual production data obtained by operating the production device 201 with the above nine sets of process parameters are illustrated, the longitudinal axis is the detected pressure proportion (the numerical value ranging from 0 to 1), and the horizontal axis is time, where each set of displayed curves consists of 1400 data.

In the first extraction step 902, the actual production data is input into an autoencoder to extract a plurality of first features. Please referring to FIG. 7, preferably, the data of 1400 actual production data are extracted to be converged into five features, the longitudinal axis is the value of the feature, and the horizontal axis is the feature; and in practice, the number of features can be determined according to actual status, which should not be limited thereto.

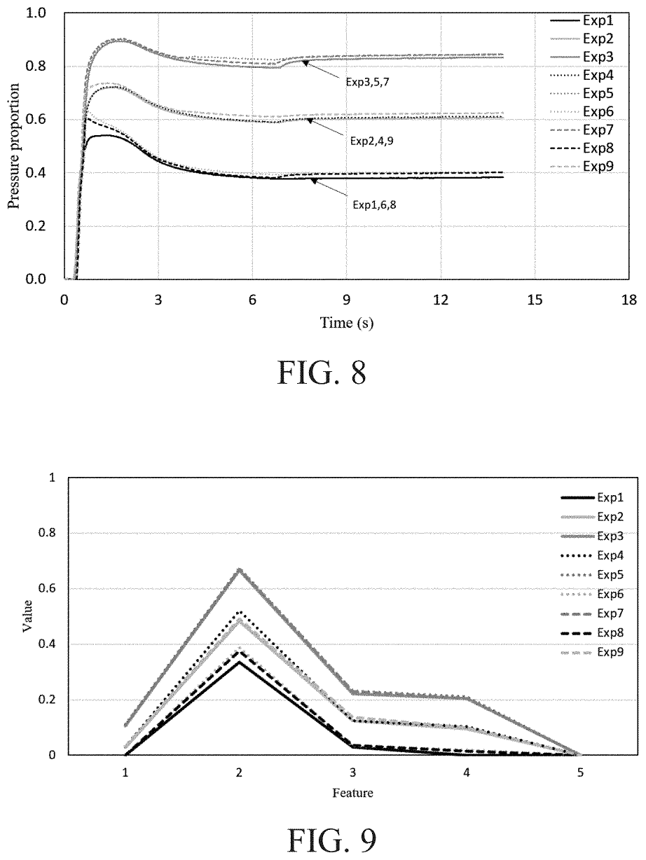

In the simulation step 903, a production prediction model is provided, the production prediction model operating based on the process parameter to produce simulated production data. Please referring to FIG. 8, curves of the simulated production data are illustrated, the process parameter is the same as the process parameter used by the production device 201, the longitudinal axis is the detected pressure proportion (the numerical value ranging from 0 to 1), and the horizontal axis is elapsed time, where each set of displayed curves consists of 1400 data.

In the second extraction step 904, the simulated production data is input into the autoencoder to extract a plurality of second features. Please referring to FIG. 9, preferably, the data of 1400 simulated production data are extracted to be converged into five features, the longitudinal axis is the value of the feature, and the horizontal axis is the feature; because the second extraction step 904 uses the same autoencoder as the first extraction step 902, the obtained features can be compared and analyzed.

Wherein in the pre-step 901 and the simulation step 903, the maximum values of the actual production data and the simulated production data are set to be 1, the minimum values of the actual production data and the simulated production data are set to be 0, and the rest numerical values of the actual production data and the simulated production data are calculated according to the proportion to obtain a plurality of data ranging from 0 to 1; if an infinite numerical value is generated, the infinite numerical value is 1, a numerical value smaller than 0 is modified into 0, and thus the actual production data and the simulated production data are converged to range from 0 to 1; similar to the concept of filtering, it is advantageous for the analytical pressure of MLP to avoid excessive gradients (a.k.a. crashes or explosions) in the calculation of the neurons, and therefore, the pressure sensing values and features in FIGS. 6, 7, 8, and 9 may range from 0 to 1.

In the training step 905, the plurality of first features and second features are input into the MLP for training to obtain a correction model, the MLP may perform back calculation using the correction model to correct the second features to be the same as the first features.

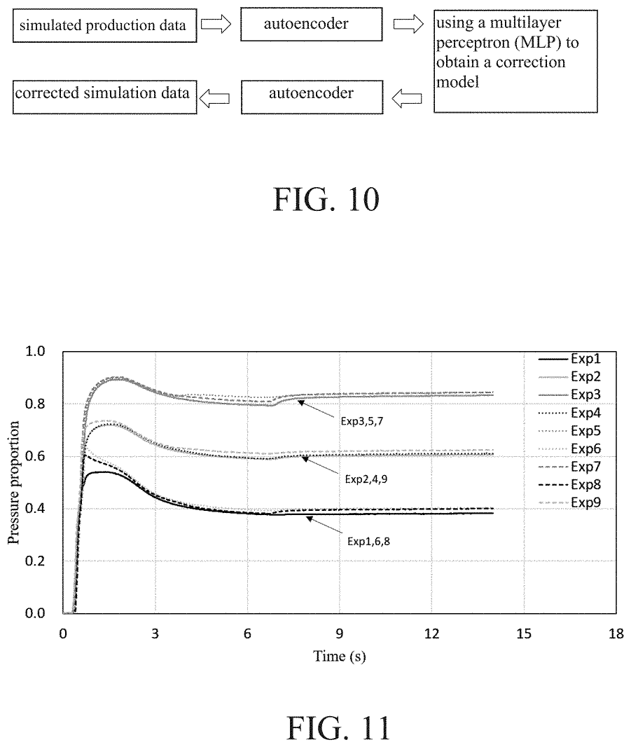

Please with reference to FIG. 10, in the importing step 906, another simulated production data is input into the autoencoder to extract a plurality of third features, wherein the another simulated production data is a result of an operation of importing another process parameter based on the production prediction model, and different simulated production data can be obtained from different process parameters.

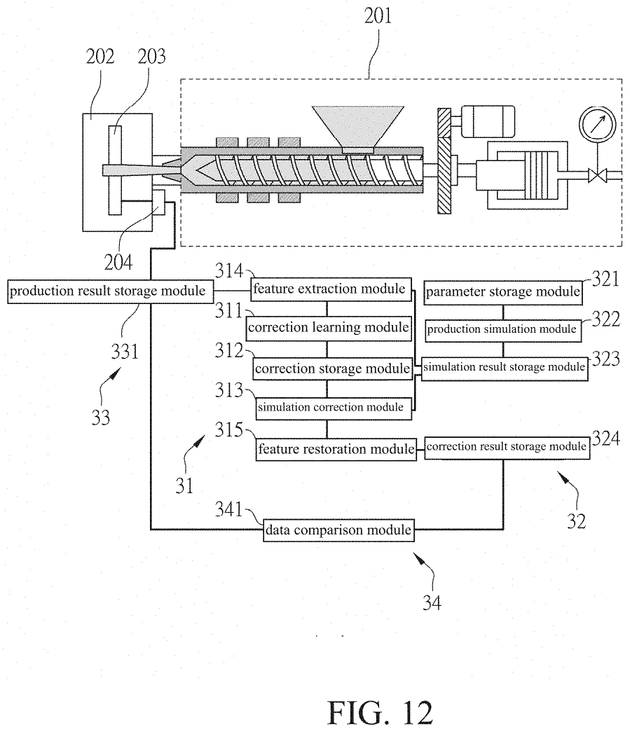

In the correction step 907, the MLP calculates the third features using the correction model to obtain a plurality of corrected features; the plurality of corrected features are then decoded by the autoencoder to obtain corrected simulation data, and the corrected simulated data also have 1400 numerical values. Please referring to FIG. 11, a curve chart of the corrected simulation data is illustrated, the longitudinal axis is the detected pressure proportion (the numerical value ranging from 0 to 1), and the horizontal axis is elapsed time. It can be learned from the curves shown in FIG. 7 and FIG. 12 that the simulated production data with the error can be corrected into the correct corrected simulation data through the correction model and by the importing step 906 and the correction step 907.

Please referring to FIG. 12, a second preferred embodiment of the present invention is illustrated; the second preferred embodiment is substantially the same as the first preferred embodiment, the same will not be descried in detail herein, and the difference is that the simulation correction unit 31 further comprises a simulation correction module 313 connected to the correction storage module 312, the production simulation unit 32 further comprises a correction result storage module 324 connected to the simulation correction module 313, and the learning apparatus further comprises a production monitoring unit 34; the production monitoring unit 34 comprises a data comparison module 341 connected to the production result storage module 331 and the correction result storage module 324; in addition, a feature extraction module 314 is arranged between the correction learning module 311 and each of the production result storage module 331 and the simulation result storage module 323, and a feature restoration module 315 is arranged between the simulation correction module 313 and the correction result storage module 324.

The simulation correction module 313 is a control circuit capable of executing programs, the MLP is stored in the simulation correction module 313, the simulation correction module 313 can correct the simulated production data into corrected simulation data by using the correction model as a computation basis of the MLP; the corrected simulation data and the actual production data have a similarity up to 99.9% or above and are regarded as the same data; the correction result storage module 324 is an electronic circuit capable of storing data, and the corrected simulation data is stored in the correction result storage module 324 by the simulation correction module 313.

The data comparison module 341 is an electronic circuit capable of executing programs, is used to compare whether the corrected simulation data is the same as the actual production data or not, and can be applied to monitoring the production status of an injection molding product. For example, the actual production data is changed due to aging of parts of the production device 201, and the data comparison module 341 can obtain the abnormal errors of the actual production data through comparison, and gives an alarm when the abnormal errors occur in the data to remind a worker to check or automatically adjust the process parameters, thus maintaining the normality of the actual production data.

The feature extraction module 314 and the feature restoration module 315 are programs and are executed in the learning apparatus or other electronic circuits to achieve the purposes of feature extraction and feature restoration: the feature extraction module 314 and the feature restoration module 315 are each provided with an autoencoder. The feature extraction module 314 may perform feature operation on numerous actual production data or simulated production data using the autoencoder to extract or converge a large amount of data, and the feature restoration module 315 is to perform inverse operation on the features to restore the actual production data or simulated production data. The feature extraction module 314 with the autoencoder can converge the features of a large amount of data to reduce the data analysis pressure of the correction learning module 311, and in practice, the correction learning module 311 can perform learning using the actual production data or the simulated production data directly without setting the feature extraction module 314 and the feature restoration module 315, which should not be limited thereto.

In accordance with the learning method for performing virtual-actual correction by machine learning-assisted simulation of the pressure numerical value, the accuracy of simulation can be improved, integration is mainly conducted on the simulated cavity pressure and actual cavity pressure under the same technological parameters, then an autoencoder model is used to extract features. In addition, the MLP is also used for performing feature fitting and further decoding to obtain the corrected simulated mold cavity pressure distribution, and then correct curve information is used to monitor actual flow behavior of the polymer melt better. The above techniques are helpful for prediction of molding quality.

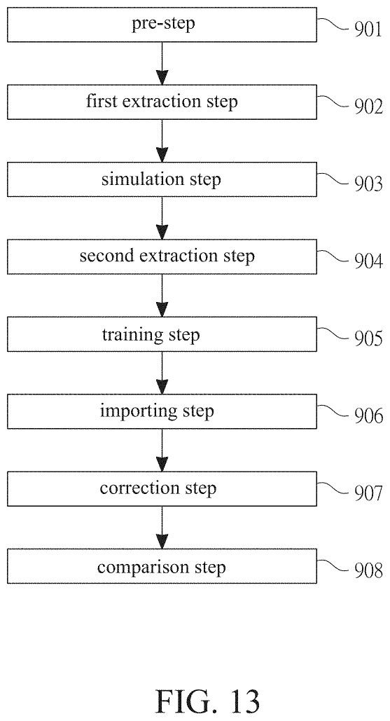

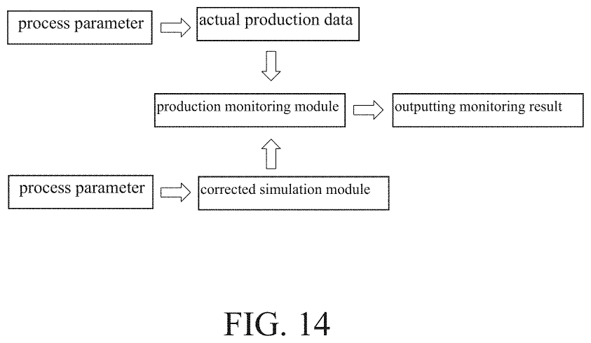

Please referring to FIG. 13 and FIG. 14, a learning method for performing virtual-actual correction by machine learning-assisted simulation of a pressure numerical value of the second preferred embodiment is illustrated, the correction method further comprises a comparison step 908 after the correction step 907.

In the comparison step 908, another process parameter is set in the production device 201 for production, a production status of the production device 201 is detected to obtain another actual production data, and whether the another actual production data is the same as the corrected simulation data or not is then judged. For example, the injection molding product produced by each mold 202 may have its own actual production data when produced using the process parameter, correct corrected simulation data may be indeed obtained through the importing step 906 and the correction step 907, and the corrected simulation data can be used to analyze whether the actual production data is normal or not, and can be provided for the technicians for problem judgment or process improvement.

It can be known from above that the learning method and the learning apparatus for performing virtual-actual correction by machine learning-assisted simulation of the pressure numerical value do have the following beneficial effects.
1. The sensing data can be accurately simulated:

the main objective of the production prediction model is to simulate operation characteristics of the production device 201, but there is an error between the simulated production data obtained through simulation and the actual production data, thus the correction learning module 311 performs analysis and learning on the simulated production data and the actual production data using the MLP to obtain the difference between the simulated production data and the actual production data and to generate the correction model; the correction model may be provided for a module with the MLP for back calculation to obtain corrected simulation data which is the same as the actual production data. The present invention does have a function of accurately simulating the sensing data of the production device 201.
2. The development time of the product is reduced:

when the correct correction model can be stored in the correction storage module 312 after being obtained by the correction learning module 311, the correction model can be provided for the developer of the injection molding product to develop simulated products with different process parameters without consuming a large amount of time and cost and using the production device 201 to adjust the process parameters; after the process parameter is adjusted to be optimal in a virtual manner, the production device 201 is used for testing the product, thus the time of developing the product using the production device 201 can be shortened.
3. The production status of the product can be monitored:

because the simulation correction module 313 can calculate the corrected simulation data which is the same as the actual production data and stores the corrected simulation data in the simulation result storage module 323, when the production device 201 is used for mass production of the products, the actual production data of each product during production can be analyzed and compared, and an alarm can be sent out when problems occur, thus the learning apparatus does have the function of monitoring the production status of the product.

In conclusion, the correction learning module 311 of the simulation correction unit 31 can perform learning for multiple times based on the simulated production data and the actual production data to obtain the correction model, the correction model can be provided for the production simulation unit 32 to obtain correct corrected simulation data, which not only can be provided for the product developer for developing products in a simulation manner, but also can monitor the operation status of the production device 201 in real time during mass production of products, thus achieving the purpose of the present invention.

However, the foregoing is only two preferred embodiments of the present invention, and cannot be used to limit the scope of the implementation of the present invention, i.e., all simple equivalent changes and modifications made in accordance with the scope of the patent application and the description of the present invention are still encompassed within the scope of the present invention.

What is claimed is:

1. A learning method for performing virtual-actual correction by machine learning-assisted simulation of a pressure numerical value, the method comprising the following steps:
a pre-step: setting a process parameter in a production device for production, and detecting a production status of the production device to obtain actual production data;
a first extraction step: inputting the actual production data into an autoencoder to extract a plurality of first features;
a simulation step: setting a production prediction model, wherein the production prediction model operates based on the process parameter to produce simulated production data;
a second extraction step: inputting the simulated production data into the autoencoder to extract a plurality of second features;
a training step: inputting the plurality of first features and the plurality of second features into a multilayer perceptron (MLP) for training to obtain a correction model;
an importing step: inputting another simulated production data into the autoencoder to extract a plurality of third features; and
a correction step, wherein the MLP calculates the third features using the correction model to obtain a plurality of corrected features, and the plurality of corrected features are decoded by means of the autoencoder to obtain corrected simulation data.

2. The learning method for performing virtual-actual correction by machine learning-assisted simulation of the pressure numerical value according to claim 1, wherein in the training step, the MLP can correct the second feature into the first feature by means of the correction model.

3. The learning method for performing virtual-actual correction by machine learning-assisted simulation of the pressure numerical value according to claim 1, wherein in the pre-step and the simulation step, the maximum values of the actual production data and the simulated production data are set to be 1, the minimum values of the actual production data and the simulated production data are set to be 0, and the rest numerical values of the actual production data and the simulated production data are calculated according to the proportion to obtain a plurality of data ranging from 0 to 1.

4. The learning method for performing virtual-actual correction by machine learning-assisted simulation of the pressure numerical value according to claim 1, wherein in the importing step, the another simulated production data is a result produced by an operation of importing another process parameter by the production prediction model.

5. The learning method for performing virtual-actual correction by machine learning-assisted simulation of the pressure numerical value according to claim 4, further comprising a comparison step after the correction step, wherein the comparison step comprises setting the another process parameter on the production device for production, and detecting a production status of the production device to obtain another actual production data, and then judging whether the another actual production data is the same as the corrected simulation data or not.

6. The learning method for performing virtual-actual correction by machine learning-assisted simulation of the pressure numerical value according to claim 1, wherein in the pre-step, the production device is an injection molding machine, and the process parameter is selected from one or a combination of a filling stroke, a material barrel temperature, a screw rotating speed, injection pressure, pressure holding time, cooling time, a mold temperature, a clamping force, an injection speed, a filling pressure holding switchover point, and holding pressure.

7. The learning method for performing virtual-actual correction by machine learning-assisted simulation of the pressure numerical value according to claim 6, wherein in the pre-step, the production device comprises a mold having at least one mold cavity, the mold being provided with at least one pressure sensor for sensing the pressure of the mold cavity to become the actual production data.

8. A learning apparatus, comprising:
a simulation correction unit, comprising a correction learning module and a correction storage module connected to the correction learning module, wherein a multilayer perceptron (MLP) is stored in the correction learning module;
a production simulation unit, comprising a simulation result storage module connected to the correction learning module, a production simulation module connected to the simulation result storage module, and a parameter storage module connected to the production simulation module, wherein a process parameter is stored in the parameter storage module, a production prediction model is stored in the production simulation module, the production prediction module corresponds to production operation features of a production device, the production simulation module executes the production prediction module using the process parameter to produce simulated production data, and the simulated production data is stored in the simulation result storage module; and
a production storage module, comprising a production result storage module connected to the correction learning module, wherein actual production data, which is an operation status of executing the process parameter by the production device, is stored in the production result storage module;
the correction learning module analyzes the simulated production data and the actual production data using the MLP to obtain a correction model, and the correction model is stored in the correction storage module.

9. The learning apparatus according to claim 8, wherein the simulation correction unit further comprises a simulation correction module connected to the correction storage module, the production simulation unit further comprises a correction result storage module connected to the simulation correction module, the MLP is stored in the simulation correction module, the simulation correction module applies the correction model to the MLP to calculate the simulated production data to obtain a corrected simulation data, and the corrected simulation data is stored in the correction result storage module.

10. The learning apparatus according to claim 9, further comprising a production monitoring unit, wherein the production monitoring unit comprises a data comparison module connected to the production result storage module and the correction result storage module, the data comparison module analyzing whether the actual production data is the same as the corrected simulation data or not.
